(19) United States
(12) Patent Application Publication
(10) Pub. No.: US 2010/0039407 A1
(43) Pub. Date: Feb. 18, 2010

(54) Sensory structure of capacitive touch panel with predetermined sensing areas

(75) Inventor: Wen-Ju Chuang, Hsinchu County (TW)

Correspondence Address: BACON & THOMAS, PLLC, 625 SLATERS LANE, FOURTH FLOOR, ALEXANDRIA, VA, 22314-1176, US

(73) Assignee: CANDO CORPORATION, Hsinchu County (TW)

(21) Appl. No.: 12/461,307

(22) Filed: Aug. 7, 2009

(30) Foreign Application Priority Data
Aug. 12, 2008 (TW) 97214408

(51) Int. Cl. G06F 3/045

(52) U.S. Cl. 345/174

(57) ABSTRACT

A sensory structure of capacitive touch panel is disclosed. The sensory structure adopts a full sensing layer therein, which is patterned in such a way that respective sensing units are formed at predetermined sensing areas, and that the sensing areas are covered. The sensory structure includes a substrate having plural wires on a first surface thereof, a sensing layer covering the first surface of the substrate and a protecting layer covering the sensing layer. The sensing layer is patterned in accordance with a predetermined arrangement of sensing areas, so as to form plural sensing units which are electrically connected to the wires respectively.

### BACKGROUND OF THE INVENTION

1. Field of the Invention

The present invention relates to a sensory structure of touch panel, and more particularly to a sensory structure of capacitive touch panel.

2. Description of the Related Art

Touch-sensing technology has been widely used for the input of electronic devices of nowadays. In this manner, pressing on the display panel by fingers or stylus allows information access or transmission, which uses no button, keyboard or joystick of a conventional electronic device.

Theoretically, touch panel is usually classified as resistive, capacitive, infrared and ultrasonic touch panel. Infrared or ultrasonic touch panel is constructed by locating an infrared or ultrasound source at one side of x-axis and y-axis of the screen respectively, and a receptor at the other side. When the user touches the screen, the movement of the infrared or ultrasound is interrupted, such that the interrupted position is calculated and confirmed. Resistive touch panel is constructed by combining upper and lower ITO (Indium Tin Oxide) conductive thin films. The upper and lower electrodes are electrified via pressure, and then the pressing position is calculated via measuring the voltage change of the panel by a controller. Conductive touch panel is constructed by a transparent glass coated with metal oxides, wherein a voltage is provided at four corners of the transparent glass to create an electric field, and the touch position is calculated by capacitance change produced from the static electricity between user's finger and the electric field.

Capacitive touch panel is advantageous of its dust proof, fire proof, scratch proof, and high resolution. However, it is easily affected by static electricity or humidity to cause errors. As the complexness of its structure and circuit, it is expected to improve the sensitiveness of capacitive touch panel without greatly increasing the fabrication cost.

U.S. Pat. No. 7,030,860 discloses a capacitive touch panel with high transmittance and sensitiveness, whose sensory structure is constructed by flexible substrate, such that it can be integrated into different kinds of electronic device. With reference to FIG. 1A, a one-dimensional sensory structure 1 of touch panel disclosed in the patent is schematically illustrated. The sensory structure 1 is constructed by combining a transparent substrate 10 and another transparent substrate 14 coated with transparent conductive layer through adhering layer 12. For two-dimensional sensory structure 100, two transparent substrates 14A and 14B coated with transparent conductive layer 16A and 16B respectively are located at two sides of insulating layer 18 in different directions (x-axis and y-axis), as shown in FIG. 1B.

However, the above-mentioned sensory structure has complicated multiple layer structure, which requires 5 to 10 fabricating procedures. Even though for the fabrication of one-dimensional touch panel, at least two substrates and one to three insulating layers are still needed, which does not accord with the requirement of electronic device of thin and light. Moreover, for the applications which have predetermined sensing areas and does not require to identify the coordinate of touching position on the whole screen, such as the touch panel of ATMs, the aforethe structure is too complicated and expensive.

In order to overcome the above-mentioned problems, it is desirable to provide a sensory structure of touch panel with predetermined sensing areas.

### SUMMARY OF THE INVENTION

It is the aspect of the present invention to provide a one-dimensional sensory structure of capacitive touch panel. The sensory structure of the present invention adopts a full sensing layer therein, which is patterned in such a way that respective sensing units are formed at predetermined sensing areas, and that the sensing units are covered. Moreover, the sensory structure of the present invention has simplified fabrication procedures to accord with its practical applications, and hence reduces the fabrication cost.

According to the aspect of the present invention, the sensory structure of capacitive touch panel includes: a substrate having plural wires on a first surface thereof; a sensing layer covering the first surface of the substrate, wherein the sensing layer is patterned in accordance with a predetermined arrangement of sensing areas to form plural sensing units which are corresponding to the position of the sensing areas and electrically connected to the wires respectively; a protecting layer covering the sensing layer, wherein part of the wires is exposed outside of the protecting layer.

Preferably, the substrate is a transparent substrate.

Preferably, the sensing layer is an indium tin oxide (ITO) layer or a transparent electrode layer.

Preferably, the sensory structure of capacitive touch panel further includes a color filter layer or a black matrix layer formed on a second surface opposite to the first surface of the substrate.

### BRIEF DESCRIPTION OF THE DRAWINGS

The above objects and advantages of the present invention will become more readily apparent to those ordinarily skilled in the art after reviewing the following detailed descriptions and accompanying drawings, in which:

FIG. 1A schematically shows the one-dimensional structure of a conventional capacitive touch panel.

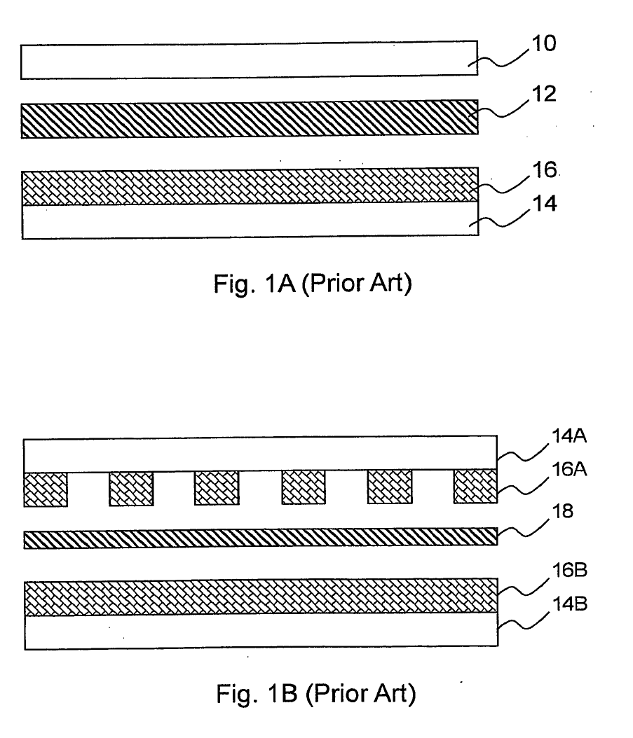

FIG. 1B schematically shows the two-dimensional structure of a conventional capacitive touch panel.

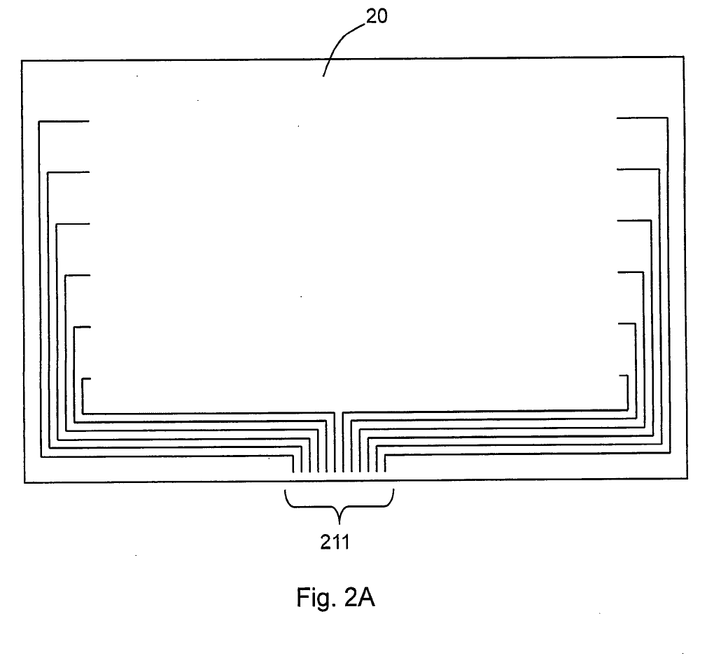

FIG. 2A to FIG. 2C schematically show the sensory structure of capacitive touch panel with predetermined sensing areas according to a preferred embodiment of the present invention.

FIG. 3 is a cross-section view of the sensory structure of capacitive touch panel with predetermined sensing areas according to a preferred embodiment of the present invention.

FIG. 4 is a cross-section view of the sensory structure of capacitive touch panel with predetermined sensing areas according to another preferred embodiment of the present invention.

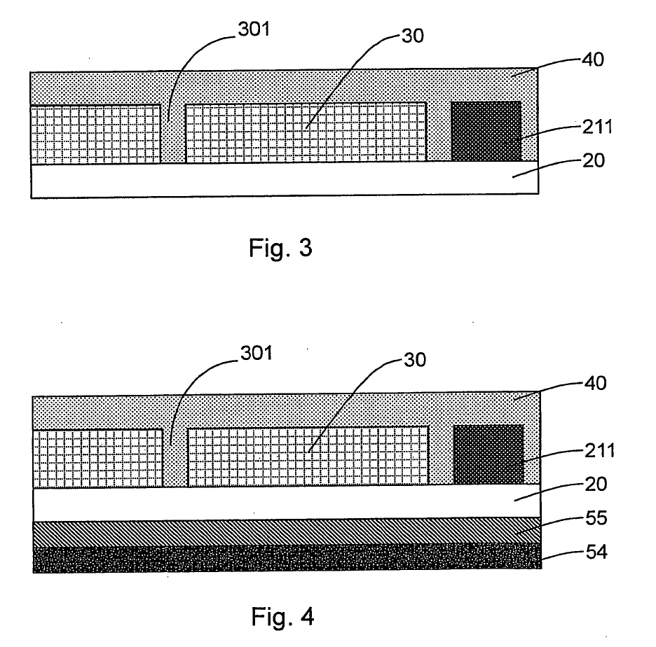

### DETAILED DESCRIPTION OF THE PREFERRED EMBODIMENT

With reference to the following disclosures combined with the accompanying drawings, the sensory structure of capacitive touch panel according to the present invention is illustrated and understood. It should be noted that the accompanying drawings are provided only for illustration where the size or scale of the elements shown therein are not necessarily the actual one. Furthermore, the description of conventional members of a touch panel is omitted to highlight the technical features of the present invention.

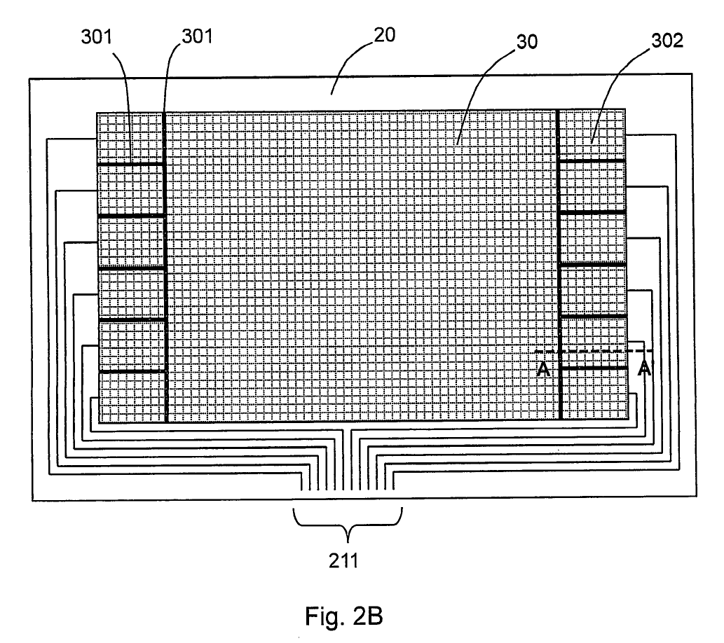

With reference to FIG. 2A to FIG. 2C, the top views of a sensory structure of capacitive touch panel with predetermined sensing areas according to a preferred embodiment of the present invention are illustrated.

With reference to FIG. 2A, firstly, a metal layer 21 is formed on a glass substrate 20, wherein the metal layer 21 is patterned to have plural of wires 211 to be used for connecting follow-up traces with external panel.

Secondly, a sensing layer 30 is provided on the metal layer 21. The sensing layer 30 is patterned in accordance with a predetermined arrangement of sensing areas to form plural sensing units 302.

In the present invention, the sensing layer 30 is an ITO sensing layer, which is patterned in accordance with a predetermined arrangement of sensing areas used in the practical application of a capacitive touch panel, such that part of the ITO sensing layer forms the sensing units 302, and insulating partitions 301 between adjacent sensing units 302. Accordingly, the configuration of the sensing units 302 is in accordance with the predetermined arrangement of sensing areas as needed in practical application, and is electrically connected to the wires 211.

Preferably, the sensing units 302 are arranged as a regular array, such as but not limited to the plural of rectangular sensing areas shown in FIG. 2B. In other embodiments, other shapes of sensing units, such as hexagon, are also applicable to be configured as needed in practical applications.

Finally, a protecting layer 40 is formed on the ITO sensing layer 30 to protect the ITO sensing layer and the metal layer, wherein part of the wires 211 is exposed outside the protecting layer 40 to form external electrical connection of the sensory structure, as shown in FIG. 2C.

In the aforethe embodiment, the wires are formed by patterning a metal layer different from the sensing layer. In other embodiments, it is also applicable to pattern a sensing layer to form the wires and the sensing units simultaneously.

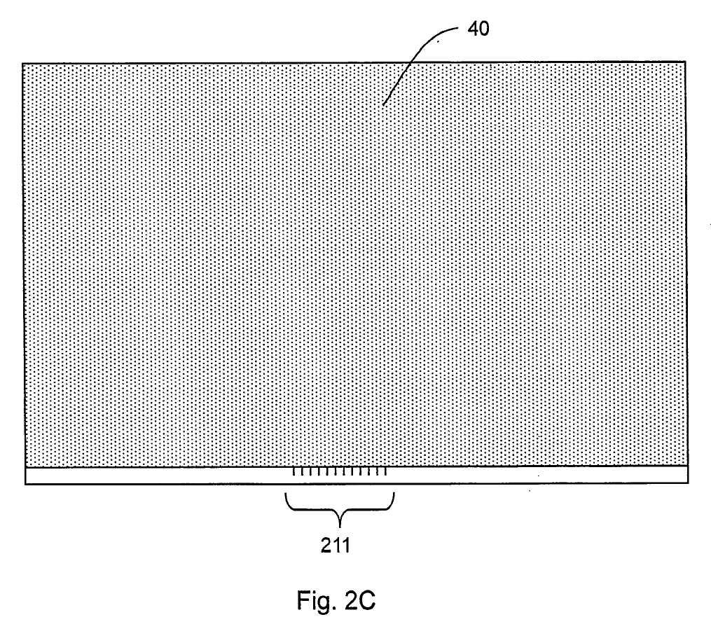

FIG. 3 is the cross-section view of the sensory structure according to a preferred embodiment of the present invention, which is taken along line AA′ in FIG. 2B. As shown in FIG. 3, the sensory structure of capacitive touch panel with predetermined sensing areas is constructed on the substrate 20 having patterned metal layer. The metal layer is patterned to form plural wires 211. A full sensing layer 30 is provided on the metal layer. As described above, the sensing layer 30 is an ITO sensing layer, and is patterned in accordance with a predetermined arrangement of sensing areas, so as to form corresponding plural sensing units, separated from each other through the via 301, in part of the ITO sensing layer. In the end, a protecting layer 40 is provided on the ITO sensing layer 30 to protect the ITO sensing layer 30 and wires 211, wherein part of the wires 211 is exposed outside of the protecting layer 40 to form external electrical connection of ITO sensing layer.

In the other embodiment of the present invention, besides ITO sensing layer, transparent electrode layer also can be used as sensing layer, and the wires can be formed by configuring ITO layer or transparent metal layer.

In order to further reduce the number of substrates required in the touch panel and hence reduce the thickness of touch panel and lower the fabrication cost, the sensing areas of full ITO sensing layer or the conventional pre-alignment technology are used to align the alignment mark, and hence to form a color filter layer 54 or black matrix layer 55 at the corresponding areas on the other side of the substrate having ITO sensing layer. As it should be, besides the embodiments of the present invention, such double layer structure of sensing and color filter layer or sensing and black matrix layer can also be used in the structure of a conventional touch panel to reduce the use of substrate and hence reduce the thickness of touch panel.

In practical application, users slightly touch the predetermined position of the screen according to the cue of the touch panel indicating predetermined options, to perform the operation. Since the position of touch sensing areas is fixed, such structure requires no complicated and precise positioning circuit module to identify the touching position, and the signal from particular position is capable to perform the operation. The sensing layer in the sensory structure of the present invention is patterned in accordance with a predetermined arrangement of sensing areas on the touch panel, so as to form the sensing units corresponding to the predetermined sensing areas. Such configuration is sufficient to be used correctly in practical applications.

To sum up, the sensory structure of capacitive touch panel with predetermined sensing areas of the present invention adopts a full sensing layer therein, which is patterned in such a way that the respective sensing units are formed at predetermined sensing areas. Such design prevents the users from seeing the sensing areas on the touch panel, and further simplifies the structure of touch panel in accordance with its practical application to reduce the fabrication cost of capacitive touch panel.

The sensory structure of capacitive touch panel with predetermined sensing areas of the present invention is advantageous of its simple structure, simplified fabrication procedure, reduced thickness and low resistance, which fits in with the tendency of thin and light of electronic devices, and more particularly is suitable to be used in the applications which have predetermined sensing areas and does not require to identify the coordinate of touching position on the whole screen (such as the touch panel of ATMs). Therefore, the present invention has industrial application, novelty, and inventiveness, and has the potential of commercialization.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A sensory structure of capacitive touch panel with predetermined sensing areas, comprising:
a substrate having plural wires on a first surface thereof;
a sensing layer covering said first surface of said substrate, wherein said sensing layer is patterned in accordance with a predetermined arrangement of sensing areas to form plural sensing units which are corresponding to the position of said sensing areas and electrically connected to said wires respectively;
a protecting layer covering said sensing layer, wherein parts of said wires are exposed outside of said protecting layer.

2. The sensory structure of claim 1, wherein said substrate is a transparent substrate.

3. The sensory structure of claim 1, wherein said sensing layer is one of an indium tin oxide (ITO) layer and a transparent electrode layer.

4. The sensory structure of claim 1, further comprising a color filter layer formed on a second surface of said substrate, wherein said second surface is opposite to said first surface of said substrate.

5. The sensory structure of claim, further comprising a black matrix (BM) layer formed on a second surface of said substrate, wherein said second surface is opposite to said first surface of said substrate.
